(19) United States
(12) Patent Application Publication
(10) Pub. No.: US 2013/0014738 A1
(43) Pub. Date: Jan. 17, 2013

(54) Saw For Cutting Silicon Into Seed Rods For Use In A Chemical Vapor Deposition Polysilicon Reactor

(71) Applicants: Paolo Molino, Lana (IT); Rodolfo Bovo, Bolzano (IT)

(72) Inventors: Paolo Molino, Lana (IT); Rodolfo Bovo, Bolzano (IT)

(73) Assignee: MEMC ELECTRONIC MATERIALS SPA, Novara (IT)

(21) Appl. No.: 13/545,093

(22) Filed: Jul. 10, 2012

Related U.S. Application Data
(60) Provisional application No. 61/508,233, filed on Jul. 15, 2011.

(51) Int. Cl. B28D 1/04

(52) U.S. Cl. 125/14; 125/12; 125/13.01

(57) ABSTRACT

Systems and methods are provided for cutting silicon into seed rods for use in a chemical vapor deposition polysilicon reactor. A method includes cutting the silicon ingot with saw blades into silicon slabs, rotating the silicon slabs, and cutting the silicon slabs into smaller-sized silicon seed rods for use in the chemical vapor deposition polysilicon reactor.

### CROSS REFERENCE

This application claims priority to U.S. Provisional Application No. 61/508,233 filed on Jul. 15, 2011, the entire disclosure of which is hereby incorporated by reference in its entirety.

### FIELD

This disclosure generally relates to systems and methods for cutting silicon and, more specifically, to a saw for cutting silicon ingots into seed rods for use in a chemical vapor deposition reactor.

### BACKGROUND

Ultrapure polysilicon used in the electronic and solar industry is often produced through deposition from gaseous reactants via a chemical vapor deposition (CVD) process conducted within a reactor.

One process used to produce ultrapure polycrystalline silicon in a CVD reactor is referred to as a Siemens process. Silicon rods disposed within the reactor are used as seeds to start the process. Gaseous silicon-containing reactants flow through the reactor and deposit silicon onto the surface of the rods. The gaseous reactants (i.e., gaseous precursors) are silane-containing compounds such as halosilanes or monosilanes. The reactants are heated to temperatures above 1000° C. and under these conditions decompose on the surface of the rods. Silicon is thus deposited on the rods according to the following overall reaction:

2HSiCl₃→Si+2HCl+SiCl₄.

The process is stopped after a layer of silicon having a predetermined thickness has been deposited on the surface of the rods. The rods are then extracted from the CVD reactor and the silicon is harvested from the rods for further processing.

The silicon seed rods used in the reactor are formed from larger blocks or ingots of silicon that are cut by a saw to form the seed rods. In known systems, these saws cut the larger silicon ingots with a number of circular-shaped blades that are disposed in a parallel arrangement. In some systems, eight blades are grouped together in a pack. Moreover, multiple packs of blades are used in a typical saw and operated at the same time to multiple larger silicon ingots. Typical saws use either two or four packs of blades. The blades in each pack are connected by a drive system to a single motor which rotates the blades. The blades and motor are movable with respect to a frame of the saw during operation. The larger silicon ingot is disposed on a stationary bed, while the blades and the motor are movable along a track.

During operation of a typical saw having packs of eight blades, each larger silicon ingot is cut by its respective pack of blades into seven smaller ingots (the two outer slabs are often discarded) as the saw travels along the track. The seven smaller ingots are then rotated 90 degrees and cut again by the saw and the two outermost rows of seed rods are often discarded. These smaller ingots are thus cut into a total of 49 silicon seed rods after this second pass through the saw.

These known saws suffer from a number of shortcomings, one of which is that they are equipped only with a single motor to rotate all the packs of blades of the saw. As such, if this motor fails the entire saw is rendered inoperable. Moreover, the design of these known saws are only operable to cut single silicon ingots having the same length and are thus unable to cut ingots having differing lengths. Further, since only a single motor is used in these known saws the rate at which the blades travel along the track during cutting is not adjustable for each individual pack of blades. That is, each pack of blades is rotated at the same rate as the others.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF SUMMARY

A first aspect is a method for cutting a silicon ingot into a plurality of smaller silicon ingots with a saw for use as silicon seed rods in a chemical vapor deposition polysilicon reactor, the saw comprising a plurality of packs of saw blades connected to at least one motor, the saw blades movable along a track connected to a frame of the saw. The method comprises cutting the silicon ingot with one of the plurality of packs of saw blades into a plurality of silicon slabs, wherein the pack of saw blades is moved along the track during cutting of the ingot at a first rate; rotating the plurality of silicon slabs 90 degrees; and cutting the plurality of silicon slabs with the pack of saw blades into a plurality of smaller-sized silicon seed rods for use in the chemical vapor deposition polysilicon reactor, wherein the pack of saw blades is moved along the track during cutting of the plurality of ingots a second rate different than the first rate.

Another aspect is a system for cutting a silicon ingot into a plurality of smaller silicon ingots for use as silicon seed rods in a chemical vapor deposition polysilicon reactor. The system comprises a frame having a first portion and an opposing second portion, the first portion and the second portion movable independent of each other along a longitudinal axis of the frame; a first group of two or more packs of blades connected to the first portion of the frame; a second group of two or more packs of blades connected to the second portion of the frame; a first motor connected to the first group of packs of blades for rotation of the first group of packs of blades; a second motor connected to the second group of packs of blades for rotation of the second group of packs of blades, wherein the first motor is connected to the first portion of the frame and the second motor is connected to the second portion of the frame.

Yet another aspect is a system for cutting a silicon ingot into a plurality of smaller silicon ingots for use as silicon seed rods in a chemical vapor deposition polysilicon reactor. The system comprises a frame having a first portion and an opposing second portion; six or more packs of saw blades connected to the frame, a first group of least three packs of saw blades connected to the first half of the frame, a second group of at least three other packs of saw blades connected to the second half of the frame; a first motor connected to the first group of packs of blades, the first motor configured to rotate the first group of packs of blades; a second motor connected to the second group of packs of blades, the second motor configured to rotate the second group of packs of blades.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a top view of a system for cutting larger silicon ingots into silicon seed rods;

FIG. 2 is a cross-sectional view of the system of FIG. 1 taken along the 2-2 line; and

FIG. 3 is a cross-sectional view of the system of FIG. 1 taken along the 3-3 line.

Like reference symbols in the various drawings indicate like elements.

### DETAILED DESCRIPTION

The embodiments described herein generally relate to systems and methods for cutting larger silicon ingots into silicon seed rods for use in a chemical vapor deposition (CVD) polysilicon reactor. These silicon seed rods are then used during production of polysilicon in the CVD reactor. While reference is made herein to cutting silicon ingots, silicon rods formed according to any suitable method may be cut to form the silicon seed rods described herein. Moreover, these systems and methods described herein may also be used to cut other semiconductor and solar materials.

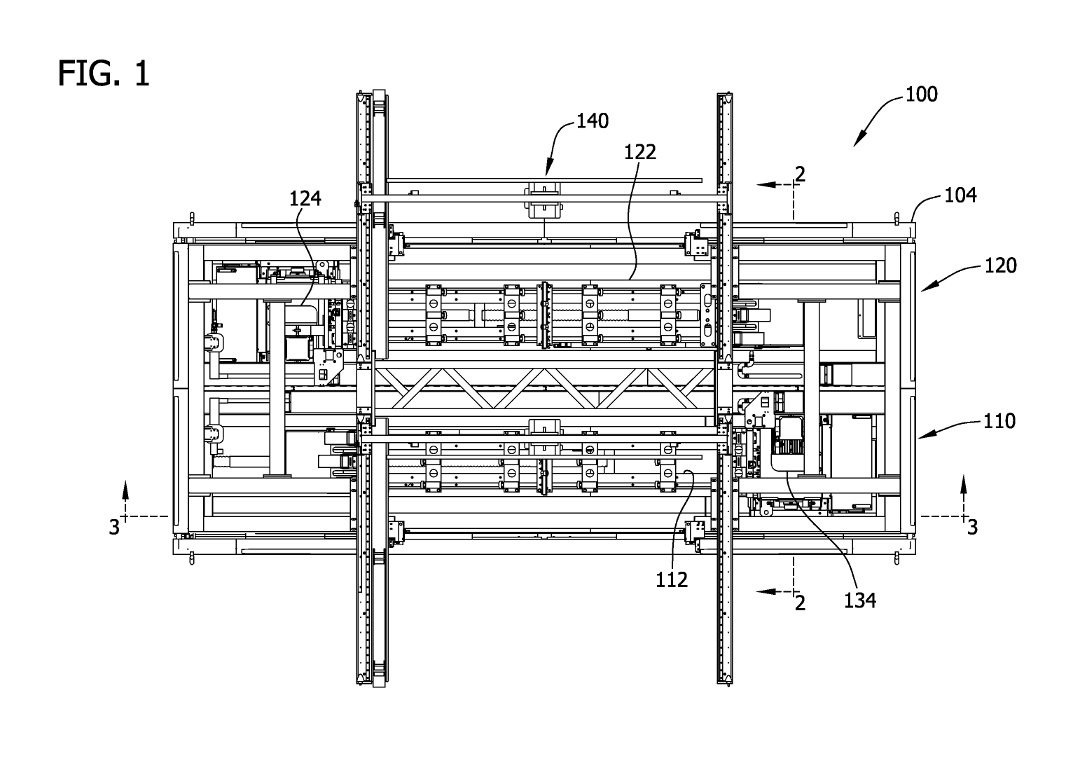

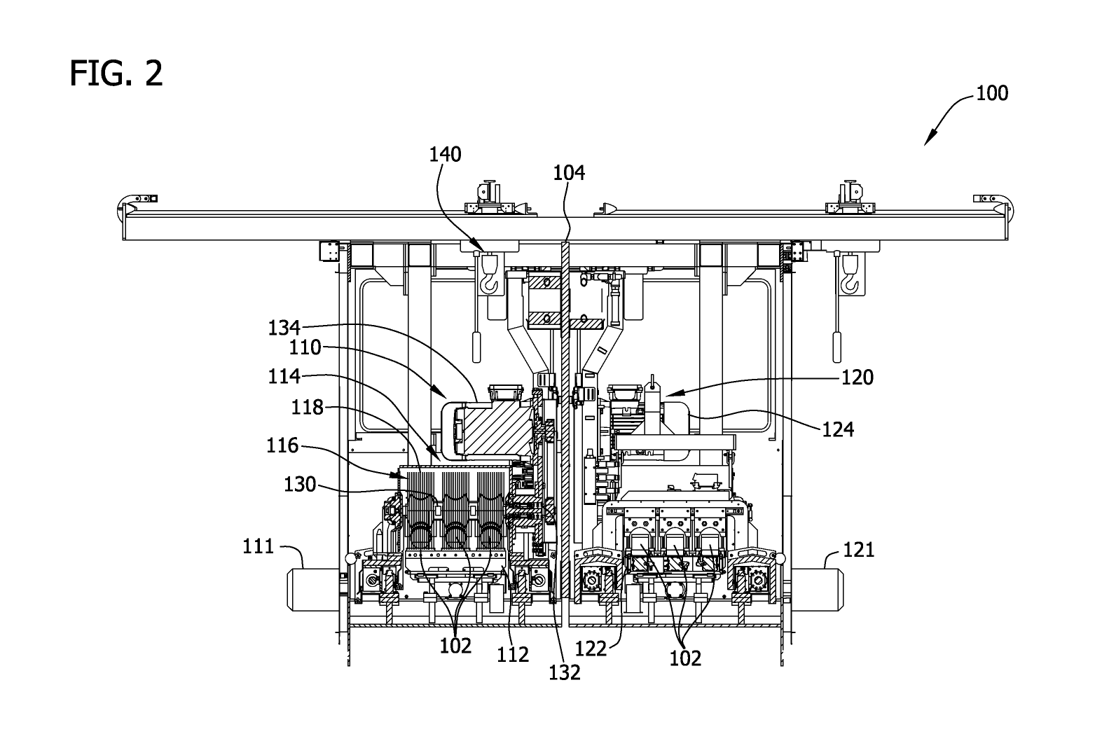

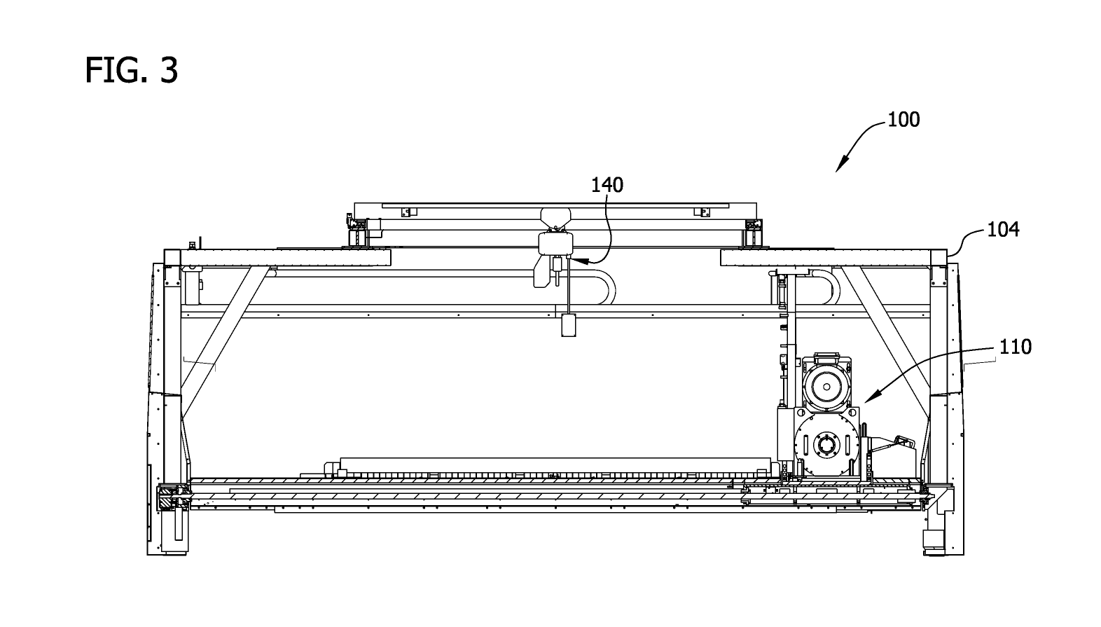

An exemplary saw system for cutting silicon ingots is indicated generally at 100 in FIGS. 1-3. The silicon ingots 102 (FIG. 2) cut by the saw 100 may be formed according to any suitable process, such as the Czochralski process. The ingots 102 typically have a circular cross-sectional shape. The ingots 102 may be differently shaped (e.g., square or rectangular) without departing from the scope of the embodiments. In the example embodiment, the larger silicon ingots 102 may have a length of up to about 3000 mm and a diameter of up to about 125 mm. The larger silicon ingots 102 may have differing dimensions without departing from the scope of the embodiments.

The system 100 has a frame 104 with a first portion 110 and an opposing second portion 120 that is laterally adjacent to the first portion. A first track 112 is connected to the first portion 110 and a second track 122 is connected to the second portion 120.

The first portion 110 is movable along the first track 112 in a direction generally parallel to a longitudinal axis of the system 100. A first actuator 111 is connected to the first portion 110 and is operable to move the first portion along the first track 112. The second portion 120 is likewise movable along the second track 122 in a direction generally parallel to the longitudinal axis. A second actuator 121 is connected to the second portion 120.

Referring to FIG. 2, a first group 114 of packs 116 of saw blades is connected to the first portion 110. The first group 114 in the example embodiment includes three packs 116 of saw blades 118 (only one of which is numbered in FIG. 2 for clarity). The blades 118 in each pack 116 are spaced apart from each other and configured to cut the larger silicon ingot into silicon seed rods. Accordingly, the blades 118 are spaced apart a distance generally equal to a desired width of the silicon seed rods. The blades 118 in each individual pack 116 of blades are connected to an arbor 130 (i.e., a mandrel) such that the blades rotate substantially in unison. The arbor 130 is in turn connected to a first drive shaft 132 that is connected to a first motor 134. Rotation of the first motor 134 thus results in rotation of the blades 118 in each pack 116 of saw blades in the first group 114. The first motor 134 is connected to the first portion 110 of the frame 104 in the example embodiment and moves along the first track 112 with the first group 114 of packs 116 of saw blades 118. In other embodiments, the first motor 134 may be connected to other structures in the system 100 such that it remains stationary or does not move in unison with the first portion 110 of the frame 104. In these embodiments, the first motor 134 is connected to the drive shaft 132 by a flexible drive shaft or other suitable power transmission system.

A second group of packs of saw blades is connected to the second half of the frame. This group of packs of saw blades are not shown for clarity, but are configured the same as or similar to the first group 114 described above. Accordingly, rotation of a second motor 124 connected to the second group of packs of saw blades thus results in rotation of these blades. The second motor 124 is connected to the second portion 120 of the frame 104 in the example embodiment and moves along the second track 122 with the second group of packs of saw blades. In other embodiments, the second motor 124 may be connected to other structures in the system 100 such that it remains stationary or does not move in unison with the second portion 120 of the frame 104. In these embodiments, the second motor 124 is connected to second group of packs of saw blades by a flexible drive shaft or other suitable power transmission system.

When referring to blades 118, packs 116, and groups 114 herein reference is intended to be made to the first group and/or the second group of packs of blades unless otherwise noted. In the example embodiment, three packs 116 of blades 118 are included in the first group 114 and the second group and each pack of saw blades includes eight individual blades. Other embodiments may use differing numbers of packs 116 of saw blades 118 or blades per pack without departing from the scope of the embodiments. Moreover, some embodiments may use a different number of packs 116 of saw blades 118 for the first group 114 and the second group (i.e., the number of packs for the first group and the second group can be different).

In the exemplary embodiment, each pack 116 of saw blades 118 is used to cut larger silicon ingots 102 into silicon seed rods. In the example described herein, the larger silicon ingots 102 have a substantially circular cross-section, although in other embodiments they may be shaped differently (e.g., square or rectangular). Ingots of differing cross-sections may be cut into silicon seed rods by the system 100. The number of blades 118 per pack 116 and/or spacing between the blades can be changed to accommodate these differently sized ingots.

During use, the larger silicon ingot 102 is first cut by one of the packs 116 of saw blades 118 into a plurality of slabs during a first pass. In the example embodiment having eight saw blades 118 per pack 116, the larger silicon ingot 102 is cut into nine slabs, and the two outermost slabs are often discarded. The remaining seven slabs are then rotated 90 degrees, either by an operator or other mechanical system. The slabs are then cut again during a second pass by the pack 116 of blades 118 into 49 silicon seed rods (the two outermost rows of seed rods are often discarded). The seed rods are then removed from the system 100 and either stored for later use or installed in a CVD reactor. Moreover, in some embodiments the two outermost slabs from the first and/or the two outermost rows of seed rods from the second pass may not be discarded.

During typical use, each pack 116 of saw blades 118 in each group 114 will be used to cut silicon ingots 102 into silicon seed rods at substantially the same time. Thus, in the example embodiment six larger silicon ingots 102 are cut by the system 100 at substantially the same time.

During use, the larger silicon ingots 102 are loaded into the system and positioned by a hoist 140 on the frame 104 prior to beginning the first pass. In the example embodiment, six larger silicon ingots 102 may be loaded into the system 100 with each positioned generally parallel to a pack 116 of blades 118. The ingots 102 may be secured to the frame 104 of the system 100 by any suitable fasteners (e.g., pneumatic clamps). The actuators 111, 121 then begin moving the first portion 110 and the second portion 120, along with the respective groups 114 of packs 116 of saw blades 118 connected to the respective portions of the frames. The motors 124, 134 rotate the groups 114 of packs 116 of saw blades 118 and the blades begin to cut the ingots 102. The actuators 111, 121 continue moving the portions 110, 120 until the ingots 102 have been cut into slabs and the first pass is complete.

Prior to commencing the second pass, the slabs are then rotated 90 degrees and may be secured to the frame 104 of the system 100 by any suitable fasteners (e.g., pneumatic clamps). The actuators then begin moving the first portion 110 and the second portion 120, along with the respective groups 114 of packs 116 of saw blades 118 connected to the respective portions of the frames. The motors 124, 134 rotate the groups 114 of packs 116 of saw blades 118 and the blades begin to cut the slabs. The actuators continue moving the portions 110, 120 until the slabs have been cut into silicon seed rods. These seed rods are then removed from the system 110 and either stored for later use or installed in a CVD reactor.

The rate of movement of the frame portions 110, 120 (and hence the groups 114 of packs 116 of saw blades 118) during the first pass and the second pass may be altered. For example, the rate of movement of the frame portions 110, 120 during the first pass may be less than the rate of movement of the portions during the second pass. For example, the rate of movement during the first pass may be about 6 mm/min and during the second pass it may be about 10 mm/min. Alternatively, the rate of movement of the frame portions 110, 120 during the first pass may be greater than the rate of movement of the portions during the second pass.

Furthermore, the rate of movement of each frame portion 110, 120 may be different during the same pass. That is, during the first pass one frame portion may be moved at a different rate than the other. One frame portion may also be moved at a different rate than the other during the second pass.

The use of two motors 124, 134 in the system described above also permits ingots 102 of differing lengths to be cut by each group 114 of packs 116 of saw blades 118. Moreover, since two motors 124, 134 are used in the system 100, if one motor fails the group of packs of saw blades driven by the other motor continue to function. Accordingly, the motor which has failed can be serviced and/or replaced while the other, operable motor and associated blades are used to continue cutting larger silicon ingots into silicon seed rods. The system described herein thus has a greater level of redundancy when compared to prior systems.

In the examples described above, the larger silicon ingot 102 and the resulting slabs remain substantially stationary during cutting by the groups 114 of packs 116 of saw blades 118. In other embodiments, the groups 114 of packs 116 of saw blades 118 remain stationary during cutting and instead the ingot 102 and resulting slabs are placed on a movable feed table (not shown). During cutting, the ingot 102 and resulting slabs are fed into the saw blades 118 by lateral movement of the feed table. An actuator or other suitable device may be used to move the feed table.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the invention, it is intended that all matter contained in the above description and shown in the accompanying drawing[s] shall be interpreted as illustrative and not in a limiting sense.

What is claimed is:

1. A method for cutting a silicon ingot into a plurality of smaller silicon ingots with a saw for use as silicon seed rods in a chemical vapor deposition polysilicon reactor, the saw comprising a plurality of packs of saw blades connected to at least one motor, the saw blades movable along a track connected to a frame of the saw, the method comprising:
cutting the silicon ingot with one of the plurality of packs of saw blades into a plurality of silicon slabs, wherein the pack of saw blades is moved along the track during cutting of the ingot at a first rate;
rotating the plurality of silicon slabs 90 degrees; and
cutting the plurality of silicon slabs with the pack of saw blades into a plurality of smaller-sized silicon seed rods for use in the chemical vapor deposition polysilicon reactor, wherein the pack of saw blades is moved along the track during cutting of the plurality of ingots at a second rate different than the first rate.

2. The method of claim 1 wherein the frame has a first portion and an opposing second portion, the first portion and the second portion being moved independent of each other during cutting.

3. The method of claim 1 further comprising changing a rate of movement of at least one of the first portion and the second portion.

4. The method of claim 1 wherein the second rate is greater than the first rate.

5. The method of claim 4 wherein the first rate is about 6 mm/min and the second rate is about 10 mm/min.

6. A system for cutting a silicon ingot into a plurality of smaller silicon ingots, the system comprising:
a frame having a first portion and an opposing second portion, the first portion and the second portion movable independent of each other along a longitudinal axis of the frame;
a first group of two or more packs of blades connected to the first portion of the frame;
a second group of two or more packs of blades connected to the second portion of the frame;
a first motor connected to the first group of packs of blades for rotation of the first group of packs of blades; and
a second motor connected to the second group of packs of blades for rotation of the second group of packs of blades, wherein the first motor is connected to the first portion of the frame and the second motor is connected to the second portion of the frame.

7. The system of claim 6 further comprising a first track connected to the first portion of the frame, the first portion of the frame movable along the first track.

8. The system of claim 6 further comprising a first actuator for moving the first portion of the frame along the first track.

9. The system of claim 6 further comprising a second track connected to the second portion of the frame, the second portion of the frame movable along the second track.

10. The system of claim 9 further comprising a second actuator for moving the second portion of the frame along the second track.

11. A system for cutting a silicon ingot into a plurality of smaller silicon ingots, the system comprising:
a frame having a first portion and an opposing second portion;
six or more packs of saw blades connected to the frame, a first group of least three packs of saw blades connected to the first half of the frame, a second group of at least three other packs of saw blades connected to the second half of the frame;
a first motor connected to the first group of packs of blades, the first motor configured to rotate the first group of packs of blades; and
a second motor connected to the second group of packs of blades, the second motor configured to rotate the second group of packs of blades.

12. The system of claim 11 wherein the first portion of the frame and the second portion of the frame are movable about a longitudinal axis.

13. The system of claim 11 further comprising a movable feed table for moving the silicon ingot with respect to the frame.

14. The system of claim 11 wherein the first portion of the frame and the second portion of the frame are movable about the longitudinal axis independently of each other.

15. The system of claim 11 wherein the first motor is connected to the first portion of the frame and the second motor is connected to the second portion of the frame.

16. The system of claim 11 wherein the first group of blades has three packs of blades and the second group of blades has three packs of blades.

17. The system of claim 11 further comprising a first track connected to the first portion of the frame and a second track connected to the second portion of the frame.

18. The system of claim 17 further comprising a first actuator for moving the first portion of the frame along the first track and a second actuator for moving the second portion of the frame along the second track.

19. The system of claim 18 wherein the first actuator is operable to move the first portion of the frame along the first track independently of the movement by the second actuator of the second portion of the frame along the second track.
